(19) United States
(12) Patent Application Publication
(10) Pub. No.: US 2008/0131850 A1
(43) Pub. Date: Jun. 5, 2008

(54) Educational building blocks and two games

(76) Inventor: Willy Danenberg, Beersel (BE)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/014,202

(22) Filed: Dec. 17, 2004

(51) Int. Cl. G09B 19/22

(52) U.S. Cl. 434/128

(57) ABSTRACT

The invention relates to blocks with special dimensions to be used for both educational and recreational purposes, teaching about proportions, ratios, and geometric figures through building games. The primary game involves strategically placing blocks down on a game board to create sets of blocks in specific figures. Players continue building sets; the first player to run out of blocks wins the game. A secondary game involves using the building blocks to reproduce models provided with the game.

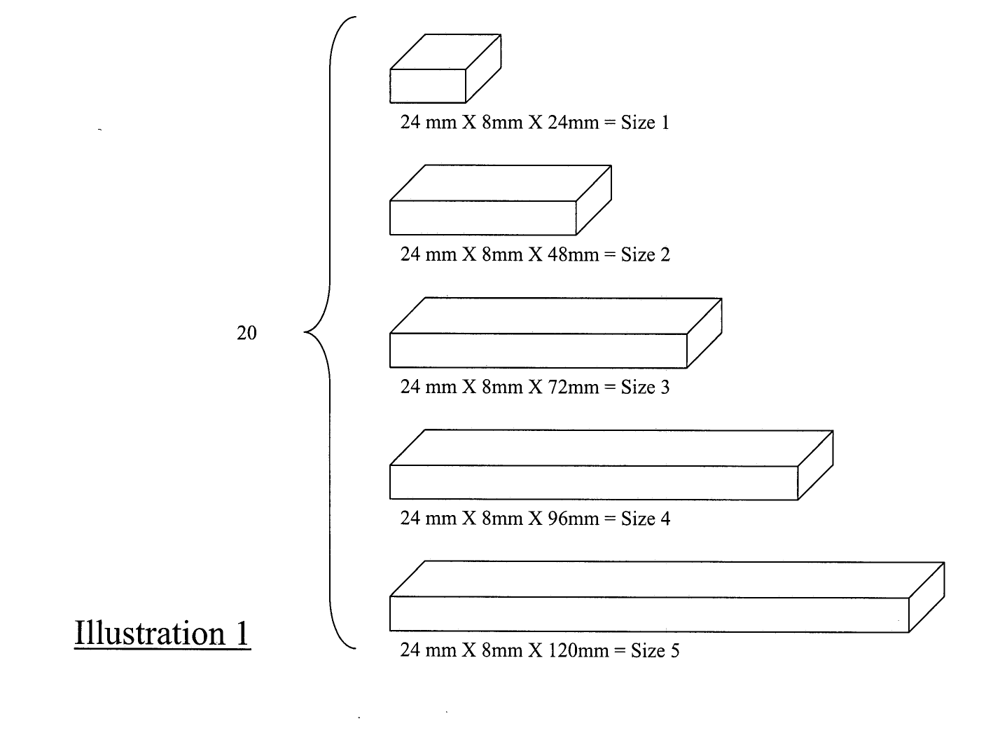

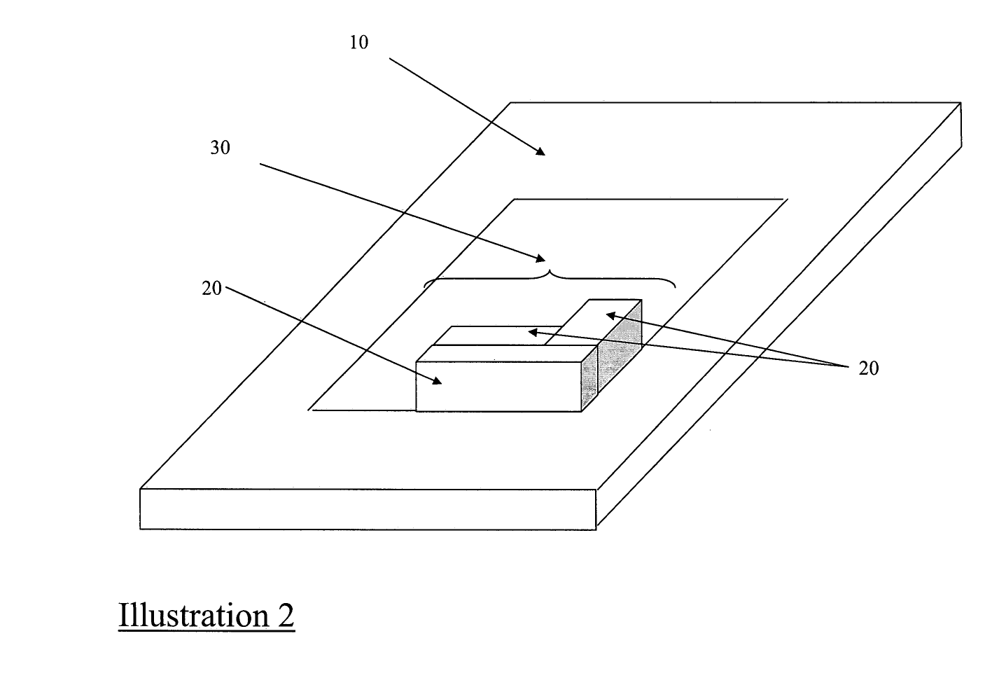

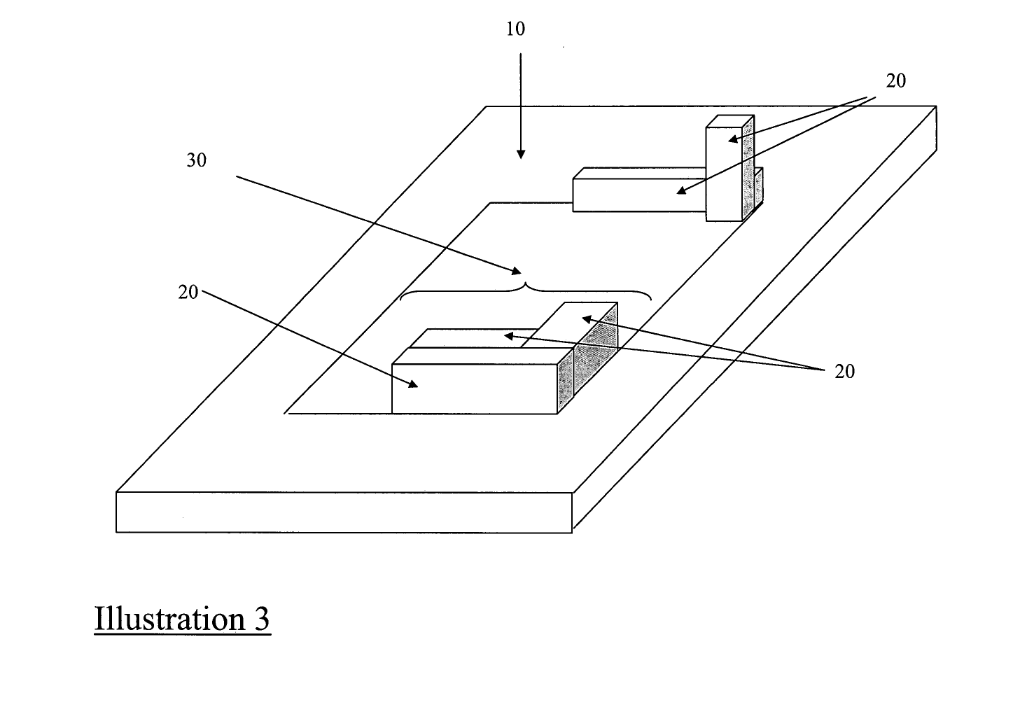

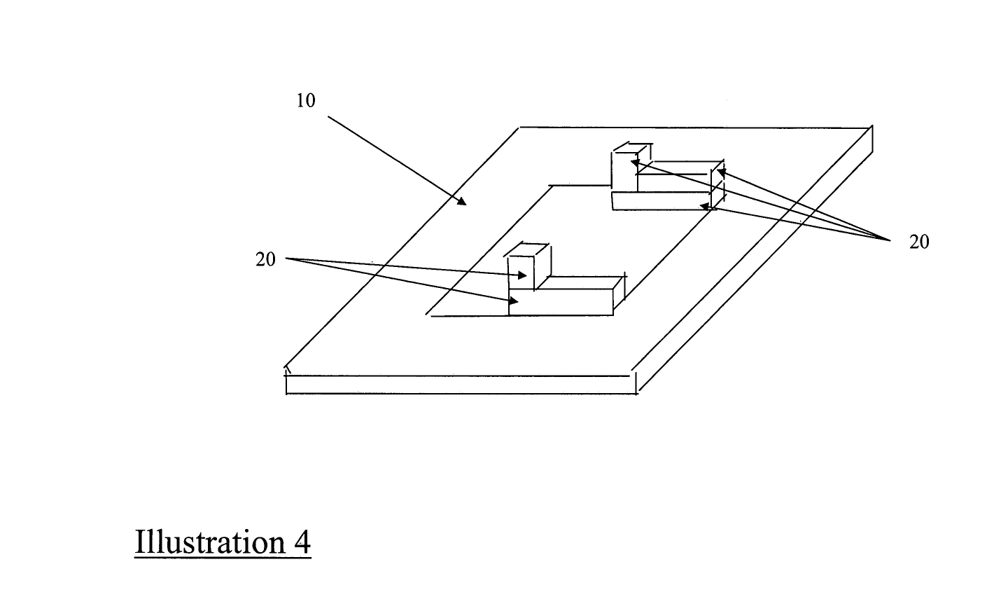

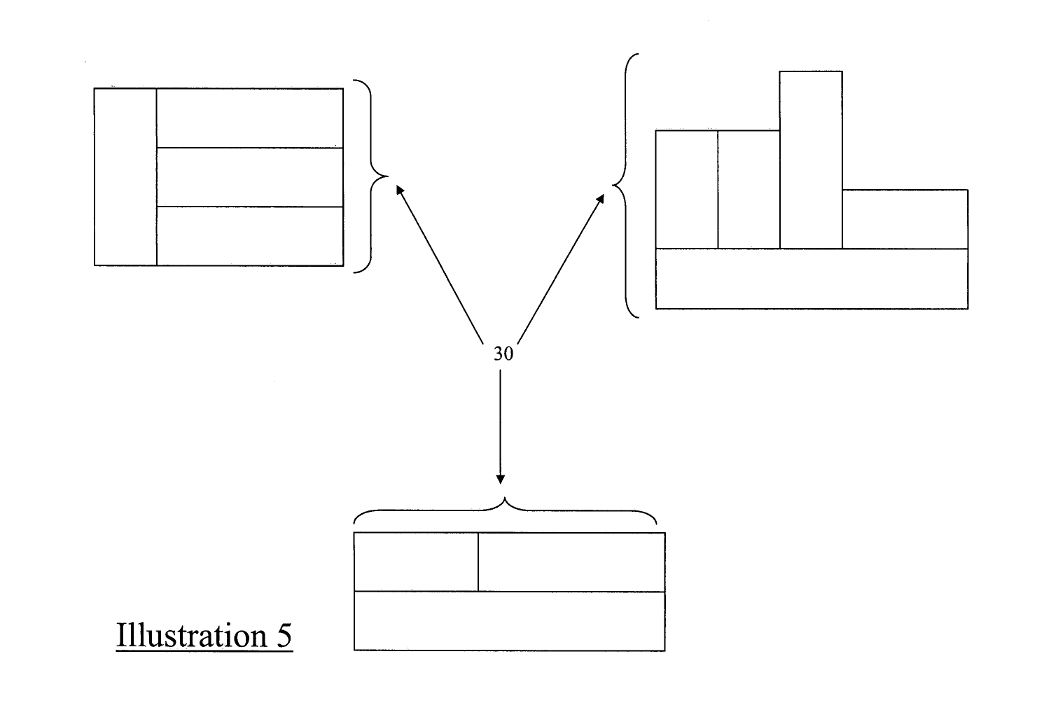

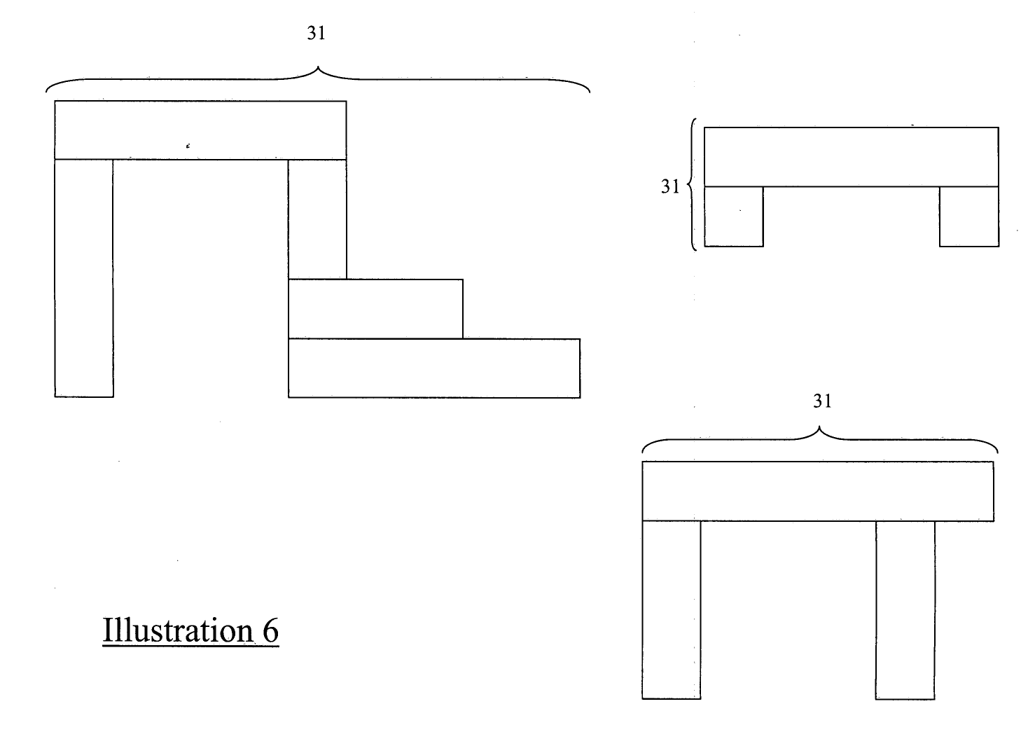

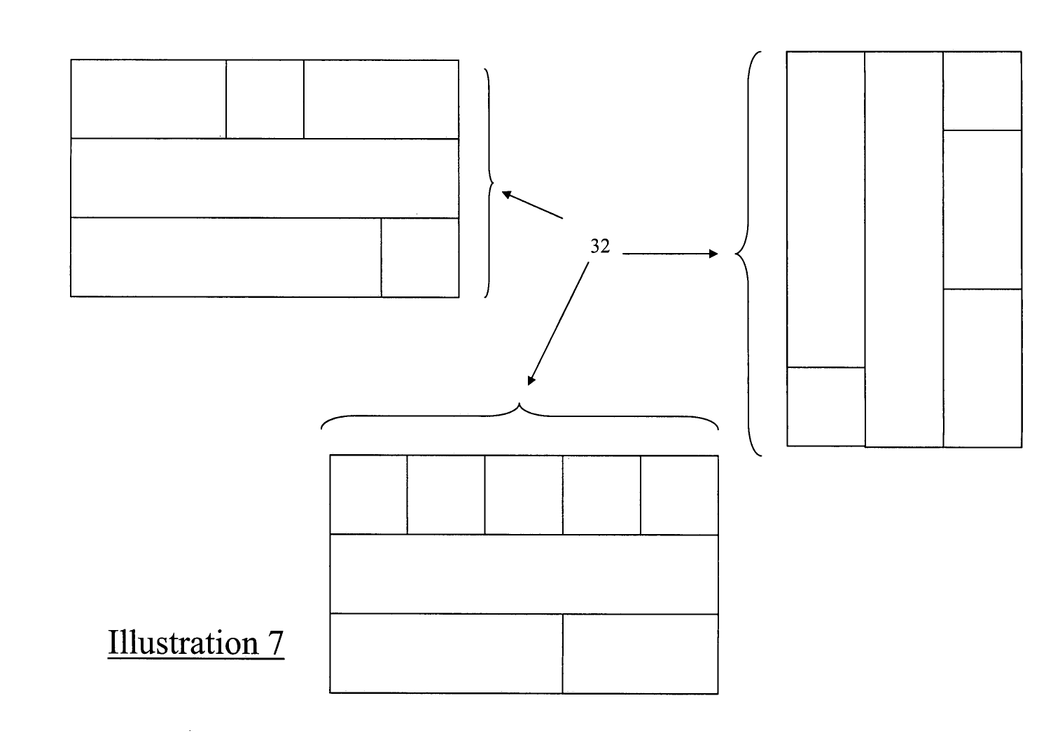

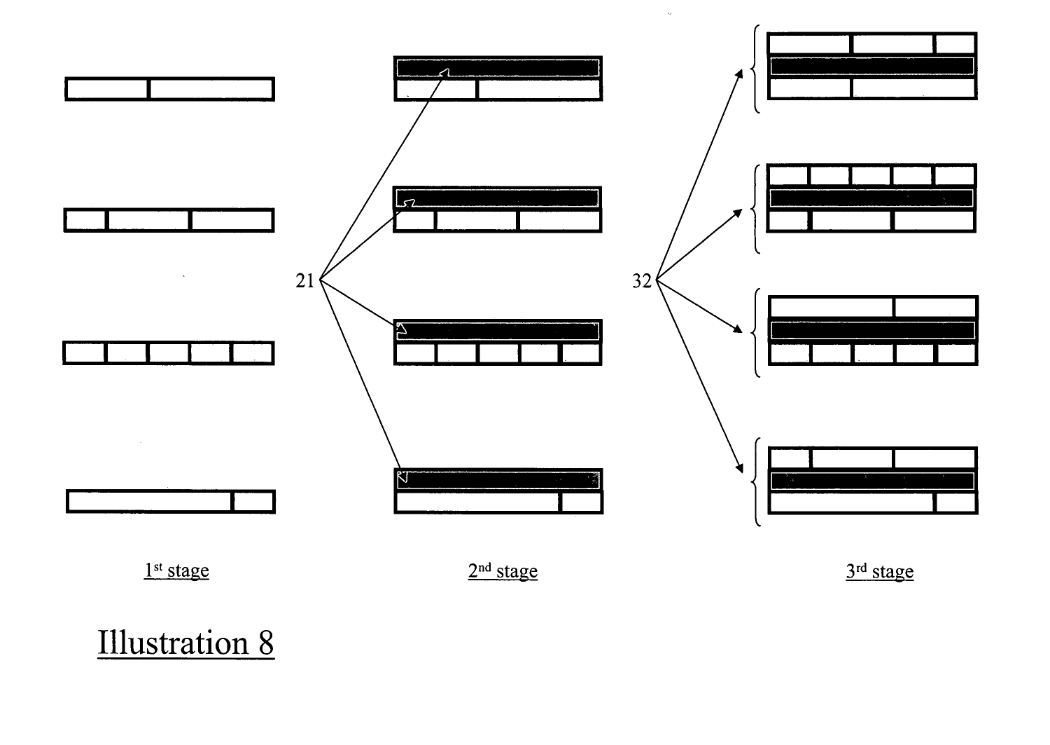

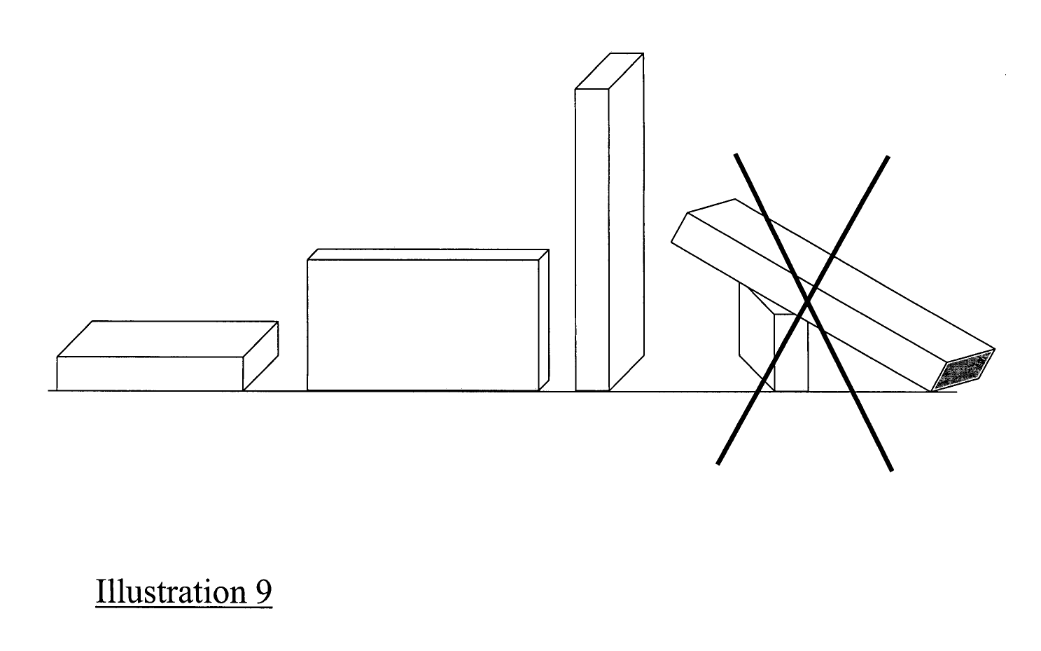

### BACKGROUND OF THE INVENTION

There is always the need for new methods of engaging and involving young people of all ages in the learning process. Interactive educational tools are especially useful for holding a child's attention. If these tools can be combined with teaching social skills and playing competitive games, the tool becomes invaluable.

The invention described herein is such an educational tool. These educational building blocks combine the challenge of a turn-taking competitive game with creativity-stimulating building blocks to create an educational device that demonstrates and teaches proportional relationships, promotes and develops manual dexterity, encourages imaginative thinking, and provides a forum for practicing and improving social interactive skills. These educational building blocks are specially designed to provide maximum educational and economic value and are ideally suited to teaching mathematical concepts such as ratios and proportions.

The Building Blocks Game is a challenging game that involves the players taking turns at precisely placing blocks to construct sets of figures. Players continue building additional figures on previously built figures, resulting in complex structures. The game finishes when only one player is left with blocks or when one player runs out of blocks. This game of strategy encourages the growth and stimulation of each player's intellectual capacity while also teaching about geometric figures and mathematical concepts. The Construction Game, a very flexible game wherein the player or players use the educational building blocks to reproduce models provided with the game, promotes creativity and coordination. Both games are easily adapted to meet the ages and skills sets of the players, ensuring that all participants, both young and old, will be challenged and entertained.

### SUMMARY OF THE INVENTION

Presented here is a building block game for educational and recreational purposes, comprising at least two different sizes of blocks, wherein the relative dimensions of the blocks comply with a fixed ratio, enabling the construction of various geometrical structures that comply with mathematical properties.

The preferred embodiment of the building block game includes five different sizes of blocks, which are supplied in a container whose lid is the game board. The dimensions of the blocks are:
Size 1=24 mm wide, 8 mm high and 24 mm long.
Size 2=24 mm wide, 8 mm high and 48 mm long.
Size 3=24 mm wide, 8 mm high and 96 mm. long.
Size 4=24 mm wide, 8 mm high and 72 mm long.
Size 5=24 mm wide, 8 mm high and 120 mm long.

The objective of the building block game is to be the first player to place all of the allotted blocks on the game board. The game is played as follows:
Equivalent numbers and types of blocks are distributed to at least two players.
Taking turns, the players place the blocks contiguous to previously placed block in order to complete predefined figures.
The player who runs out of blocks first is declared the winner.

Completing predefined figures give the players the opportunity to place additional blocks on the game board, thereby increasing the possibility of winning.

One of the predefined figures is a brick figure, which is completed when the surface of one block is completely covered by at least two other blocks.

Another of the predefined figures is a bridge figure, created by placing one block over two previously played blocks whose uppermost surfaces are of equal height.

The third predefined figure is the Hamza figure, the most complex and challenging for the figures, which is created in three stages:
Placing the final block that completes a set of blocks equaling the length of a predetermined fixed size block,
Placing a fixed size block over said set of blocks,
Placing an additional set of blocks on the fixed sized block, the length of said set of blocks equaling the length of a predetermined fixed size block.

When a player completes a predefined figure, that same player can place another block any place on the board game or start a new layer on the existing construction. However, a player completing a Hamza figure may not place another block on that same figure in the same turn.

The first figure must be built in one of the four corners of the game board.

Each newly placed block must make contact with the last played block.

The blocks may be placed on any of their six sides, horizontally, vertically or on end.

If a player causes blocks to fall, that player is obliged to take all of the fallen blocks.

The user is restricted to use of only one hand when placing blocks on the game board.

### BRIEF DESCRIPTION OF DRAWINGS

These and further features and advantages of the invention will become more clearly understood in light of the ensuing description of a preferred embodiment thereof, given by way of example only, with reference to the accompanying drawings, wherein—

Illustration 1 shows the relationship of five block sizes to one another.

Illustration 2 describes a perspective view of the game board with a single brick figure completed.

Illustration 3 describes a perspective view of the game board with a single brick figure completed and another figure in process.

Illustration 4 describes a perspective view of the game board with several figures in process.

Illustration 5 shows three samples of Brick figures, wherein each Brick is completed when the surface of one block is covered by the sides of at least two other blocks.

Illustration 6 shows three samples of Bridge figures, where each Bridge is completed when one block is placed horizontally across two other blocks.

Illustration 7 shows three examples of Hamza figures, where the Hamza figure is completed when a combination of blocks is placed over a size 5 block.

Illustration 8 details the three phases of constructing the Hamza figure, where the first phase is the completion of a set of blocks totaling the length of a size 5 block, the second phase is the placement of the size 5 block over this set, and the third phase is placing additional blocks over the size 5 block.

Illustration 9 describes examples of legal and illegal placements of blocks.

### DESCRIPTION OF THE PREFERRED EMBODIMENT

The Blocks

The present invention describes a series of blocks (20) of specific dimensions that can be used for both educational and recreational purposes by following the rules of the games described herein. Additionally, other games and educational uses can be determined by the users. The preferred embodiment of the invention comprises 240 building blocks (20) of assorted sizes that are stored in storage container with a removable lid equipped with a game board (10).

The building blocks (20) are supplied in five precise sizes. The dimensions of the blocks (20) have been specially designed to teach about ratios and proportions. The widths and heights of all the blocks (20) are the same, 24 mm wide by 8 mm high. The lengths of the blocks (20) increase in increments of 24 mm. Illustration 1 shows this relationship of the five different sizes of blocks (20) to one another. The lengths and distributions of the blocks (20) are as follows:
One hundred each of Size 1 blocks, measuring 24 mm long;
Eighty each of Size 2 blocks, measuring 48 mm long (=size 1+size 1);
Twenty each of Size 3 blocks, measuring 72 mm long (size 2+size 1);
Twenty each of Size 4 blocks, measuring 96 mm long (=size 3+size 1);
Twenty each of Size 5 blocks, measuring 120 mm long (=size 4+size 1).

In an alternative embodiment, a total of 76 building blocks (20) are supplied, where the dimensions of the blocks (20) are the same as above, and the distribution is as follows:
Forty-four each of Size 1 blocks;
Twelve each of Size 2 blocks;
Eight each of Size 3 blocks;
Eight each of Size 4 blocks;
Four each of Size 5 blocks.

In the preferred embodiment, the blocks (20) are constructed of wood; however there is also the option of constructing any of the game parts from any material that has the properties of being easy to clean, inexpensive and long lasting.

In the preferred embodiment, the blocks (20) are divided into four equal sets, as described below, and each set is respectively colored blue, red, brown, and natural. However, there is the option of assigning any color combination or no color to each set of blocks (20).

In the preferred embodiment, the building blocks (20) come supplied in and can be stored in a storage container equipped with a handle. The storage container and handle can be of any style and material that provides sufficient size and strength to contain all of the blocks (20).

In the preferred embodiment, said storage container is also equipped with a completely removable lid, which also functions as the game board (10). In another embodiment, the game board (10) is supplied within and may be stored in the storage container.

The game board (10) measures 120 mm long by 120 mm wide, the length of the size 5 block (21). In the preferred embodiment, the game board (10) is of a bright yellow color; however there is the option to design the board in any color.

Because the games can be adapted to the ages and developmental stages of the players, the educational building blocks (20) provide many pedagogical uses. Both the building blocks and construction games help develop coordination, creativity, imagination, and intellectual capacity. Additionally, the games teach social skills such as following rules, sharing, and exchanging ideas and acquaint players with the mathematical concepts of proportions, ratios, and geometric shapes.

The Games

Building Block Game

This is a game of strategy for two, three, or four players, where the players place building blocks (20) on the game board (10) in various combinations to create figures. The objective of the game is to be the first player to place all of his or her blocks (20) on the game board (10) by completing as many figures as possible, without making the construction fall.

The playing area of the game is the entire surface of the game board (10). In the preferred embodiment, the game board (10) is located in the center of the lid of the storage container; in alternative embodiments, the game board (10) may be a separate object. The building blocks (20) should not be placed outside of the playing area of the game board (10). The entire game board (10) playing area does not need to be used in the course of the game.

The three primary figures that the players must try to build are defined as follows:
The Brick figure (30), as seen in Illustration 5, is the basic figure of this game. A Brick figure (30) is completed when the surface of one block is completely covered by the sides of at least two other blocks (20). It is possible that a Brick figure (30) may also encompass a Bridge (31) or a Hamza (32), both described below.
A Bridge (31) is created by placing one block over two previously played blocks whose uppermost surfaces are of equal height. Illustration 6 demonstrates several examples of completed Bridge figures (31).
The Hamza figure (32), comprised of three layers of equal length wherein the middle layer is a single size 5 block (21), is the most complex figure of the game, and also provides the player with the opportunity to play the greatest number of building blocks (20) in one turn. Illustration 7 shows some examples of possible Hamza (32) figures. The Hamza (32) figure is built in three stages, as shown in illustration 8.
   In the first phase, a player places the final block (20) that completes a set of blocks (20) equaling the length of a size 5 block (21).
   The second stage is completed when the same player then places a size 5 block (21) over the set of blocks completed in stage 1.
   In the third stage, the same player then has the opportunity to completely cover the size 5 block (21) with additional blocks (20) thereby completing the Hamza figure (32).

Once all of the size 5 blocks (21) have been used, no additional Hamza figures (32) can be built.

Each time a player places a block (20) on the game board so that it completes any of these figures, that player gets to place another block (20) anywhere on the game board (10). However, the player who completes a Hamza figure (32) may not place another block on that same figure but must place the next building block (20) elsewhere on the game board (10).

Figures can be built along any of the horizontal or vertical edges of the lead block.

A player cannot start building a new figure unless at least one figure has been completed. Each new block placed on the playing board must contact the last block (20) that was placed on the game board (10). However, once a player has finished one figure, that player has the possibility of placing a new building block (20) anywhere on the playing surface (10). The next player can place his or her block (20) on any side of that block. For example, if the first building block of a new figure is placed on end, perpendicular to the board, the next building block (20) can then be placed on any of the four sides of the lead block.

Playing the Game:

This game is played with two, three, or four players. Each player is allotted a set of blocks, the distribution of which is determined by the total number of blocks in the set. If fewer than four people are playing the game, the remaining blocks are set aside and not used.

If using the 240 block set, each player is provided with 60 blocks, broken down as follows:
25 each of the size 1 blocks,
20 each of the size 2 blocks,
5 each of the size 3 blocks,
5 each of the size 4 blocks,
5 each of the size 5 blocks.

If using the 76 block set, each player is provided with 19 blocks, as follows:
11 each of the size 1 blocks,
3 each of the size 2 blocks,
2 each of the size 3 blocks,
2 each of the size 4 blocks,
1 each of the size 5 blocks.

The game is played out by taking turns in the specific order of the predetermined turns, with each player placing their building blocks (20) on the game board (10), one by one.

Any method can be used to determine who begins the game and the order of each player's turn. One suggested method is drawing lots or pulling straws. Another suggestion is to take four blocks (20) of different sizes and hide them under the game board (10). Each player pulls one block. The player with the largest block begins and so on. The last player is the one who pulls the smallest block.

The game begins with the first player placing any size building block (20) in any corner of the game board (10). Each subsequent building block (20) must be placed adjacent to any side of the last block played. Examples of block placement can be seen in illustrations 2, 3 and 4. The rounds continue, each player's building block contributing further to the construction of a figure.

Each time a player completes one of the figures described above, that player has the opportunity to place another block (20) on the board (10). At this point, the player chooses between placing a block (20) on an existing figure, or placing a block (20) somewhere on the game board (10) and starting a new figure. Both illustrations 3 and 4 show sample game boards (10) with one completed figure and a second figure in process of being built. However, the player who completes a Hamza figure (32) may not place another block on that same Hamza figure but must place the next building block (20) elsewhere on the game board (10).

When placing the blocks on the game board (10), the blocks may be placed on any of their six sides, horizontally, vertically or on end. Placing the blocks diagonally, however, is not allowed. These options are more clearly explained in illustration 9.

The first figure must be built in one of the four corners of the game board (10). Once there is a completed figure in one corner, subsequent figures may be started anywhere on the board, including on an existing figure. The only additional placement requirement is that each block must make contact with the last played block.

During the game, the game board (10) may not be moved, nor can the players move around when placing a block.

If a player causes any part of the construction fall during the course of his turn, that player has to take all the fallen blocks (20).

The turns continue until all of the building blocks (20) are placed on the game board. The winner is the first player to run out of blocks (20). The loser is the player left with the most blocks (20) or the last player to put all his or her blocks (20) on the board.

Suggested Optional Rules for the Building Block Game:

Players can invent other figures to complete, in addition to the three primary figures.

Players can only use one hand when placing blocks (20) on the game board (10).

The winner chooses five blocks (20) and gives them to the loser for the next game.

For the next game, the loser gets the first turn.

Construction Game

This game can be played alone or with any number of players. The object of the game is to recreate the models included in or on the storage container. Due to the nature of the game, the rules are determined by and adapted to individual preferences and player abilities. Additionally, the players can use the blocks (20) to create original constructions.

While the above description contains many specificities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A building block game for educational and recreational purposes, said game comprising at least two different sizes of blocks, wherein the relative dimensions of the blocks comply with a fixed ratio, enabling the construction of various geometrical structures that comply with mathematical properties.

2. The building block game of claim 1 further comprising the steps of:
distributing equivalent numbers and types of blocks to at least two players;
placing a leading block by a first player on game board;
at each round of the game, placing at least one additional block by each player contiguous to any block in order to complete predefined figures;
if a predefined figure is complete, the same player can place another block any place on the board game or start a new layer on the existing construction;
if one or more blocks falls during the turn of a specific player, said player is obliged to take all fallen blocks;
the player who runs out of blocks first is declared the winner.

3. The building block game of claim 1 including five different sizes of blocks.

4. The building block game of claim 2 wherein one of the predefined figures is a brick figure, wherein the Brick figure is completed when the surface of one block is completely covered by at least two other blocks.

5. The building block game of claim 2 wherein one of the predefined figures is a bridge figure, wherein the Bridge figure is created by placing one block over two previously played blocks whose uppermost surfaces are of equal height.

6. The building block game of claim 2 wherein one of the predefined figures is a Hamza figure, said Hamza figure comprised of three layers of equal length, wherein the middle layer includes a single block having a fixed size length;

7. The building block game of claim 6 wherein said Hamza figure is created according to the following steps:
placing the final block that completes a set of blocks equaling the length of a predetermined fixed size block;
placing a fixed size block over said set of blocks;
placing an additional set of blocks on the fixed sized block, the length of said set of blocks equaling the length of a predetermined fixed size block;

8. The building block game of claim 2 wherein the blocks may be placed on any of their six sides, horizontally, vertically or on end.

9. The building block game of claim 2 wherein the first figure must be built in one of the four corners of the game board.

10. The building block game of claim 2 wherein each newly placed block must make contact with the last played block.

11. The building block game of claim 2 wherein the user is restricted to use of only one hand when placing blocks on the game board;

12. The building block game of claim 2 wherein all of the fallen blocks go to the player who made them fall

13. The building block game of claim 6 wherein the player completing a Hamza figure may not place another block on that same figure in the same turn.

14. The building block game of claim 1 wherein the dimensions of one type of block are 24 mm wide, 8 mm high and 120 mm long.

15. The building block game of claim 1 wherein the dimensions of one type of block are: 24 mm wide, 8 mm high and 72 mm long.

16. The building block game of claim 1 wherein the dimensions of one type of block are: 24 mm wide, 8 mm high and 96 mm. Long.

17. The building block game of claim 1 wherein the dimensions of one type of block are: 24 mm wide, 8 mm high and 48 mm long.

18. The building block game of claim 1 wherein the dimensions of one type of block are: 24 mm wide, 8 mm high and 24 mm long.
